(19) United States
(12) Patent Application Publication
(10) Pub. No.: US 2016/0042172 A1
(43) Pub. Date: Feb. 11, 2016

(54) METHOD AND APPARATUS FOR UNLOCKING DEVICES

(71) Applicant: SAMSUNG ELECTRONICS CO., LTD., Suwon-si (KR)

(72) Inventors: Suraj Govind CHIPLUNKAR, Bangalore (IN); Anki CHO, Suwon-si (KR); Avirag Narendra SRIVASTAVA, Bangalore (IN); Madhur BAJAJ, Bangalore (IN)

(73) Assignee: SAMSUNG ELECTRONICS CO., LTD., Suwon-si (KR)

(21) Appl. No.: 14/819,915

(22) Filed: Aug. 6, 2015

(30) Foreign Application Priority Data
Aug. 6, 2014 (IN) 3854/CHE/2014

(51) Int. Cl. G06F 21/36; G06F 3/01; G06F 1/32; G06F 3/0488

(52) U.S. Cl. CPC G06F 21/36; G06F 3/04883; G06F 3/013; G06F 1/3231

(57) ABSTRACT

Methods and apparatuses for unlocking a device with enhanced security level are provided. The method includes: receiving a first input indicating a reference point, receiving an input pattern including a plurality of inputs in a plurality of directions, wherein each of the plurality of inputs is initiated from the reference point, determining whether the plurality of inputs included in the input pattern are substantially identical to a plurality of inputs included in predetermined unlocking data; and unlocking the device based on the determination.

### CROSS-REFERENCE TO RELATED PATENT APPLICATION

This application claims the benefit of Indian Patent Applications No. 3854/CHE/2014, filed on Aug. 6, 2014 and on Jun. 4, 2015, in the Indian Patent Office, the disclosure of which is incorporated herein in its entirety by reference.

### BACKGROUND OF THE INVENTION

1. Field of the Invention

Methods and apparatuses consistent with the present invention generally relate to an unlock mechanism for electronic devices. The present invention more particularly relates to a non-visual method for a user who is blind, a user with poor eyesight, or a user who is not able to use his or her hand to unlock a device.

2. Description of the Related Art

A lock screen is highly necessary for touch screen devices, such as smart phones because users have a large amount of personal information stored in their devices. Business, on-line shopping and banking transactions are also possible using touch screen devices. Currently, touch screen devices have visual password, pass-code or unlocking techniques.

### SUMMARY OF THE INVENTION

The present invention provides a method and apparatus for enabling users to unlock touch sensitive devices.

According to an aspect of the present invention, there is provided a method for unlocking a device, the method comprising receiving a first input as a reference point, receiving a plurality of inputs in a plurality of directions, wherein each of the plurality of inputs is initiated from the reference point, determining whether the plurality of inputs in the plurality of directions are substantially identical to a predetermined unlocking data, and unlocking the device based on the determination.

The method may further include waking up the device from a sleep mode when receiving a wake-up input.

The method may further include displaying a plurality of contour lines radiating from the reference point, calculating each of a plurality of distances between the reference point and each of the plurality of inputs in the plurality of directions, wherein the determination whether the plurality of inputs in the plurality of directions are substantially identical to the predetermined unlocking data comprises determining whether a combination of the plurality of inputs in the plurality of directions and the plurality of calculated distances are substantially identical to the predetermined unlocking data.

The method may further include displaying a virtual object on a display of the device based on a determination that the first input is received on a predetermined reference point.

The reference point is a predetermined point on a display of the device.

The predetermined point is a central point of the display of the device.

The reference point is an arbitrary point on a display of the device and the first input is automatically determined to be the reference point.

The plurality of inputs are swipe gesture inputs and the device is a touch sensitive device.

The receiving the first input as a touch input and the receiving the plurality of inputs as swipe gesture inputs are performed discontinuously.

The plurality of inputs are generated by a plurality of eye movements and the device is a head-mounted device.

The plurality of inputs are generated by a plurality of movement of any of limbs of a user and the device is a motion sensitive device.

The device is one of a mobile phone, a head-mounted device, a electronic watch device, a vehicle console, a TV and a computing device.

The method may further include displaying a virtual object which is movable on a display of the device; and allowing the virtual object to move along with the plurality of inputs in the plurality of directions on a display of the device.

The displaying the virtual object comprises displaying the virtual object on a predetermined location on a display of the device before receiving the first input as the reference point.

The displaying the virtual object comprises after receiving the first input as the reference point, displaying the virtual object on a location where the first input is received.

The method may further include displaying a closed curve on the display of the device, and wherein the allowing the virtual object to move comprises allowing the virtual object to move along with the plurality of inputs substantially within the closed curve on the display of the device.

The closed curve is either a circle or a polygon.

According to another aspect of the present invention, there is provided an apparatus for unlocking from a lock state, the apparatus comprising a receiver configured to receive a first input as a reference point and to receive a plurality of inputs in a plurality of directions, wherein each of the plurality of inputs is initiated from the reference point; a processor configured to determine whether the plurality of inputs in the plurality of directions are substantially identical to a predetermined unlocking data and to unlock from the lock state based on the determination; and a memory configured to store the predetermined unlocking data.

The apparatus may further include a waking-up receiver configured to receive a wake-up input, wherein the processor is configured to perform a waking-up from a sleep mode upon receipt of the wake-up input.

The apparatus may further include a display configured to display a virtual object which is movable on the display, wherein the processor is configured to allow the virtual object to move along with the plurality of inputs in the plurality of directions.

The display is configured to display the virtual object before receipt of the first input as the reference input.

The display is configured to display the virtual object after receipt of the first input as the reference input.

The display is configured to display a closed curve and the processor is configured to allow the virtual object to move along with the plurality of inputs substantially within the closed curve.

The closed curve is either a circle or a polygon.

The display is configured to display a plurality of contour lines radiating from the reference point and the processor is configured to calculate each of a plurality of distances between the reference point and each of the plurality of inputs in the plurality of directions and to determine whether a combination of the plurality of inputs in the plurality of directions and the plurality of calculated distances are substantially identical to the predetermined unlocking data.

The display is configured to display the virtual object based on a determination that the receiver receives the first input on a predetermined reference point.

The reference point is a predetermined point on a display.

The reference point is an arbitrary point corresponding to the first input.

The plurality of inputs are swipe gesture inputs and the apparatus is a touch sensitive device.

The receiver is further configured to receive the first input as a touch input and to receive the plurality of inputs as swipe gesture inputs discontinuously.

The plurality of inputs are generated by a plurality of eye movements and the apparatus is a head-mounted device.

The plurality of inputs are generated by a plurality of movement of any of limbs of a user.

The apparatus is one of a mobile phone, a head-mounted device, a electronic watch device, a vehicle console, a TV and a computing device.

According to another aspect of the present invention, there is provided a method of unlocking a device, the method comprising: receiving a first input as a reference point; receiving a plurality of sequential visits on a plurality of areas on a display of the device; determining whether the plurality of sequential visits on the plurality of areas are substantially identical to a predetermined unlocking data; and unlocking the device based on the determination, wherein the plurality of areas are divided by contour linens radiating from the reference point.

The method may further include displaying either of numbers or alphabets on the plurality of areas.

The plurality of sequential visits are made by at least one of touch inputs, eye movements of a user, and movements of any of limbs of the user.

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B illustrate prior art in which a user unlocks a device based on patterns displayed on the device;

FIG. 2 illustrates a method of unlocking a device with an enhanced level of security, according to an exemplary embodiment of the present invention;

FIGS. 3A and 3B illustrate a method of unlocking a head mounted device which receives eye movements as user inputs, according to an exemplary embodiment of the present invention;

FIG. 4 illustrates a method of unlocking a motion sensitive device which receives an input based on movement of a limb of a user, according to an exemplary embodiment of the present invention;

FIGS. 5A and 5B illustrate a method of unlocking a device with an input based on contour lines, according to an exemplary embodiment of the present invention;

FIGS. 6A and 6B illustrate another method of unlocking a touch sensitive device with a virtual object, according to an exemplary embodiment of the present invention;

FIG. 7 illustrates another method of unlocking a touch sensitive device with an input based on multiple finger touches, according to an exemplary embodiment of the present invention;

FIGS. 8A through 8D illustrate another method of unlocking a device, according to an exemplary embodiment of the present invention.

FIG. 9 is a block diagram of an apparatus for unlocking a device, according to an exemplary embodiment of the present invention;

FIG. 10 is a flowchart of a method for unlocking a device, according to an exemplary embodiment of the present invention.

FIG. 11 is a schematic diagram illustrating division of the touch sensitive screen into plurality of sectors with respect to directions from a central point, according to an exemplary embodiment of the present invention.

FIG. 12 is a schematic diagram illustrating S cover for unlocking the touch screen, according to another embodiment of the present invention.

FIG. 13 is a schematic diagram illustrating location based change of unlocking data for unlocking the touch screen, according to an embodiment of the present invention.

### DETAILED DESCRIPTION OF THE INVENTION

Hereinafter, the present invention will be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those of ordinary skill in the art.

Also, while describing the present invention, detailed descriptions about related well-known functions or configurations that may diminish the clarity of the points of the present invention are omitted. The terms used herein are defined considering functions in the present invention, and thus may differ according to intentions or customs of a user or an operator. Accordingly, the terms are defined based on the overall descriptions in the specification. Also, when a part “includes” an element, the part may include another element unless otherwise defined. For convenience of description, an apparatus and a method may be described together if required.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the drawings, like reference numerals denote like elements, and if required, an element shown on another drawing may be referred to. The sizes of elements may be exaggerated for clarity.

Hereinafter, one or more embodiments of the present invention will be described with reference to the attached drawings.

Blind users and users having poor eyesight cannot see UI elements clearly on touch screen devices. Present unlocking techniques use keys, patterns, passwords, facial recognition, pin numbers, voice, finger prints, etc. for unlocking electronic devices. Unlocking a device using facial and voice recognition has accuracy issues. Inputting unlock patterns on a display of a device is difficult for blind users based on eyesight. Pin numbers and passwords have two issues. First, when using a pin and a password, blind users use voice guidance services such as text-to-speech, voiceovers, etc. which read the UI components and keys out loud, thus making a device less secure. Second, a relatively long amount of time may be required to focus on a desired key, receive feedback from voice guidance and then input the key.

Therefore, it is time consuming for blind users to unlock a phone. Finger print recognition methods are fast but still have accuracy issues under certain conditions.

Therefore, there is a need for non-visual unlocking techniques for the blind. In addition, such unlocking techniques should be able to optionally display a visual UI so that same technique can be used by the blind as well as people with normal vision.

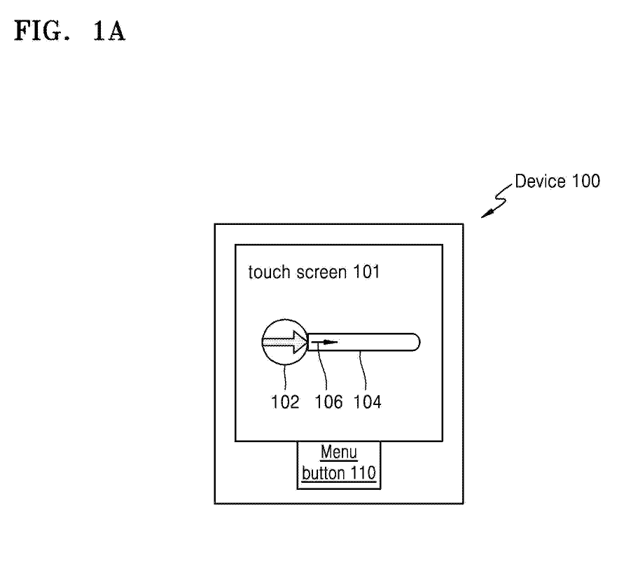

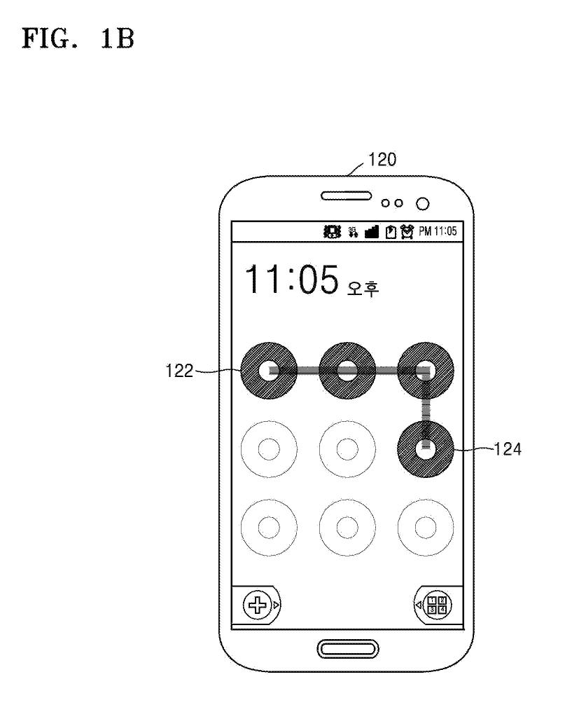

FIG. 1 illustrates prior art in which a user unlocks a device based on patterns displayed on a device.

In FIG. 1A, a device displays a pattern by which a user of the device is able to unlock the device. In order to unlock the device, the user may touch the indicator 102 and drag it along with the preset path 104 in a predetermined direction 106.

As shown in FIG. 1A, since anyone can recognize how to unlock the device, i.e. no other pattern is required for unlocking the device, the security level of the device is quite low.

FIG. 1B shows another common example of unlocking a device. A user of the device 120 inputs a dot pattern by touching a starting point 122 and passing through other dots to unlock the smart device. Provided that the path made by touching and passing-through is identical to a registered path, the device gets unlocked. Referring to the example of FIG. 1B, often times the device displays the whole path for unlocking based on an option selected by a user, which is also vulnerable to shoulder surfers.

Therefore, there is needed a security-enhanced method of unlocking a smart device without displaying patterns on a smart device or looking at the screen i.e., non-visual interaction.

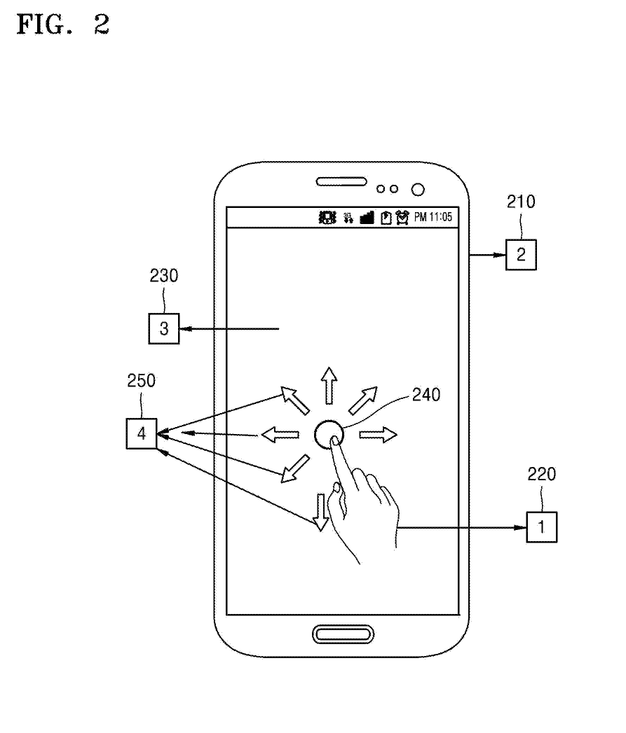

FIG. 2 illustrates a method of unlocking a device with an enhanced level of security, according to an exemplary embodiment of the present invention.

Since a device usually maintains a sleep mode or a power saving mode if the device is not used for a long time, a user is first required to activate or wake up the device from the sleep mode. In order to activate the device, various methods can be used such as pressing a predetermined hard/soft key or hard/soft button, swiping a touch screen of the device, or making a voice input etc. Once the device is activated or woken-up from a sleep mode or sleep status, the device requests the user to input a password for unlocking the device.

In accordance with the FIG. 2, the device receives an input from a user and the point of the first input is recognized as a reference point for unlocking the device. The reference point can be a predetermined point on a display of the device. A typical example of the reference point is a center point of a display of the device. Therefore, if the user fails to touch the predetermined point on the display of the device, then the device does not initiate an unlocking process and the device may opt to provide a visual or audio notice to a user such as “Reference Point not Detected.” In response to the notice, the user may attempt to touch another point to initiate the unlocking process. In another embodiment of the present invention, the device may be able to assist the poor-eyesight user or the blind to locate the reference point more easily. Soon after completing a “waking-up” process, the device provides feedback to the user if he or she is trying to find out the reference point. For instance, the device can provide haptic or audio feedback to inform the user that he can proceed to the unlocking process when he or she succeeds in placing his or her finger on the reference point of the display of the device.

In another embodiment of the present invention, the reference point is set by an arbitrary touch input made by a user on a display of the device. In other words, if the device senses the first touch input by a user after being woken-up from the sleep mode, the device automatically determines the point of the first touch input as the reference point.

Once the reference point is determined, the user makes a plurality of swipe gestures in a plurality of directions to unlock the device. For instance, the user's swipe gestures are made from the reference point in the up direction, the right direction, the left-diagonal-down direction, and the left direction sequentially. Based on a user's choice, the order of the swipe gestures may or may not contribute to establishing a security code. If the order of the swipe gestures is not an essential element for satisfying the security code, it is only important whether the user's swipe gestures are made in certain predetermined directions. For example, if the security code requires user's swipe gestures to be made in the up, down and right-diagonal-up direction, the user's sequential swipe gestures in the right-diagonal-up, down, and up directions in sequence are also valid inputs for unlocking the device. By contrast, if the order of the swipe gestures is a critical element for satisfying the security code, the aforementioned inputs are not valid for unlocking the device. To unlock the order-sensitive security code device in the aforementioned example, the user is required to make sequential swipe gestures in the up, down and right-diagonal-up directions.

When the device receives the sequential swipe gestures from the user, the device compares the received sequential swipe gestures in a plurality of directions with a predetermined unlocking data. The predetermined unlocking data or alternatively, a predetermined unlocking path is stored in a memory of the device by a user at a setting mode prior to the user's sequential swipe gestures for unlocking the device.

Since the unlocking method described referring to FIG. 2 does not display any pattern on a display of the device, it is very difficult for a third party to learn the security code over the device user's shoulder. In addition, if the reference point is an arbitrary point where the user makes the first touch input, the blind or a poor eyesight person can easily unlock the device because the blind or a poor eyesight person need not locate the reference point. Even if the device adopts a fixed reference point such as central point on a display of the device, the blind or a poor eyesight person can also easily unlock the device based on overall size of the device or with a voice guidance of “Reference Point not Detected” provided by the device.

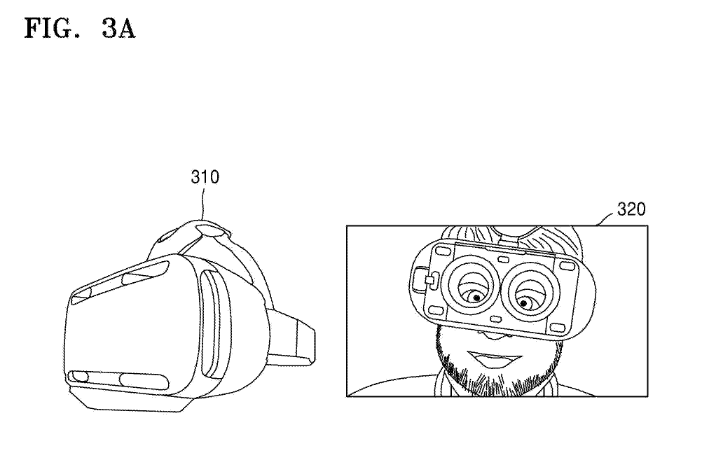

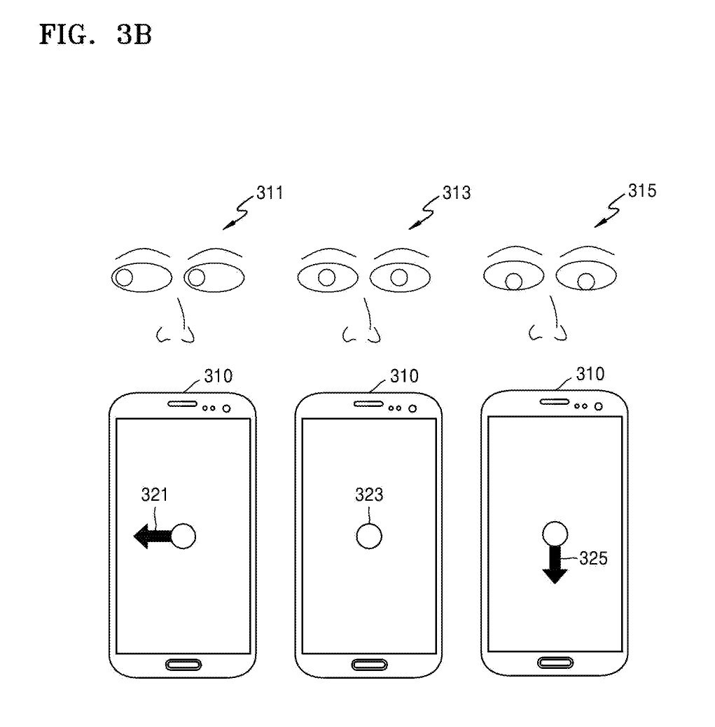

FIGS. 3A and 3B illustrate a method of unlocking a head-mounted device which receives eye movements as user inputs, according to an exemplary embodiment of the present invention.

A user can use a head-mounted device 310 by mounting the device on his or her head 320 as shown in FIG. 3A. The device senses user's eye movements as inputs. As shown in FIG. 3B, the device senses an eye movement in the left direction 311 and receives the movement as an input in the left direction 321 on the device. Likewise, the device senses another eye movement in the down direction 315 as an input to the device in the down direction 325. If the user maintains his or her gaze toward a center position 313, the device recognizes it as the reference point input 323.

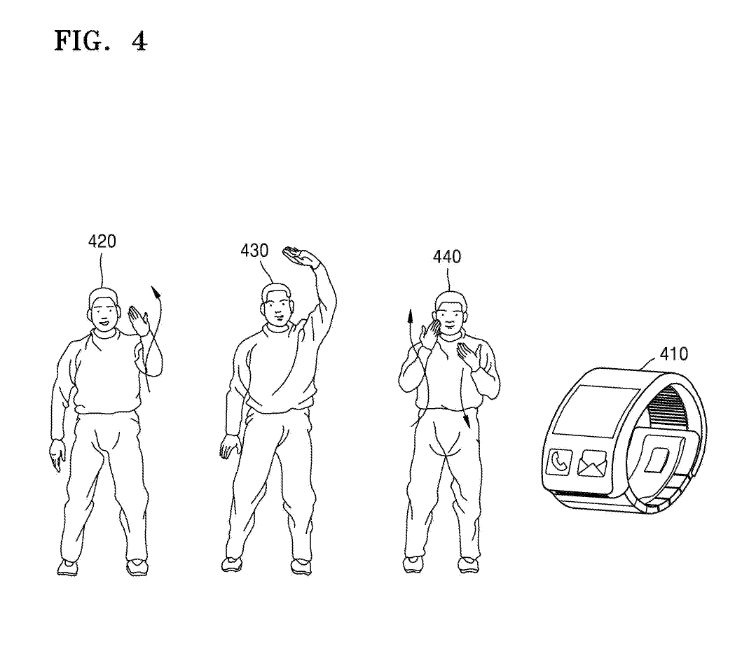

FIG. 4 illustrates a method of unlocking a motion sensitive device which receives an input based on movement of a limb of a user, according to an exemplary embodiment of the present invention.

The user may wear a motion sensitive wearable device such as a smart watch, smart glasses, an electronic bracelet, and a pendent necklace, etc. The motion sensitive wearable device senses movement of a limb or a head of the user and recognizes the motion as an input with a motion sensor. For example, in accordance with the gestures 420, 430 and 440 of the user, the motion sensitive device may receive corresponding inputs in the predetermined direction. In other words, if the user wearing a smart watch stretches his arm to the right, the smart watch senses the corresponding motion and recognizes it as an input to the right of the device. Therefore, if a combination of a plurality of motions made by the user corresponds to a predetermined password data or a predetermined path stored in a memory of the motion sensitive wearable device, the motion sensitive wearable device such as the smart watch becomes unlocked from a locked state.

The movement inputs in the motion sensitive wearable device are detected using motion sensing, camera, EEG, EMG or any other sensor based device (wearable or non-wearable) which identify touch, movement, gesture, eyeball movement, or any other human performable interactions.

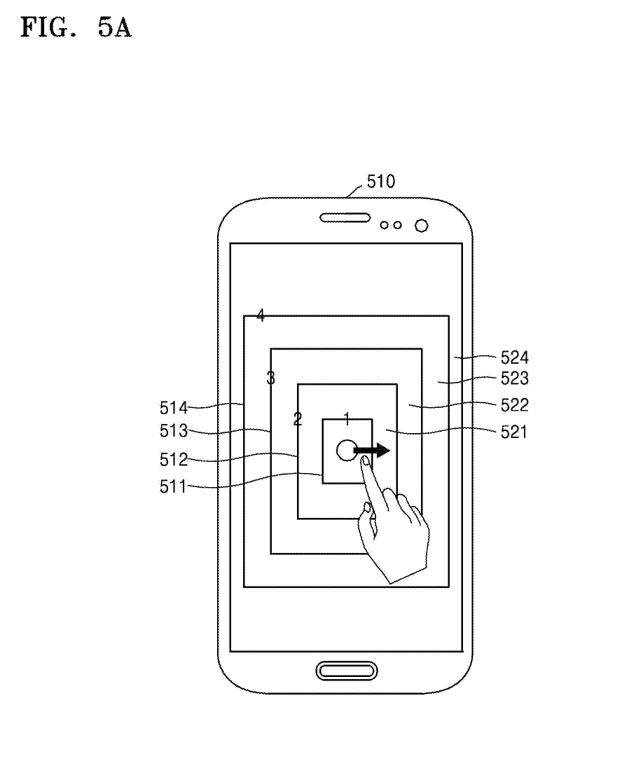

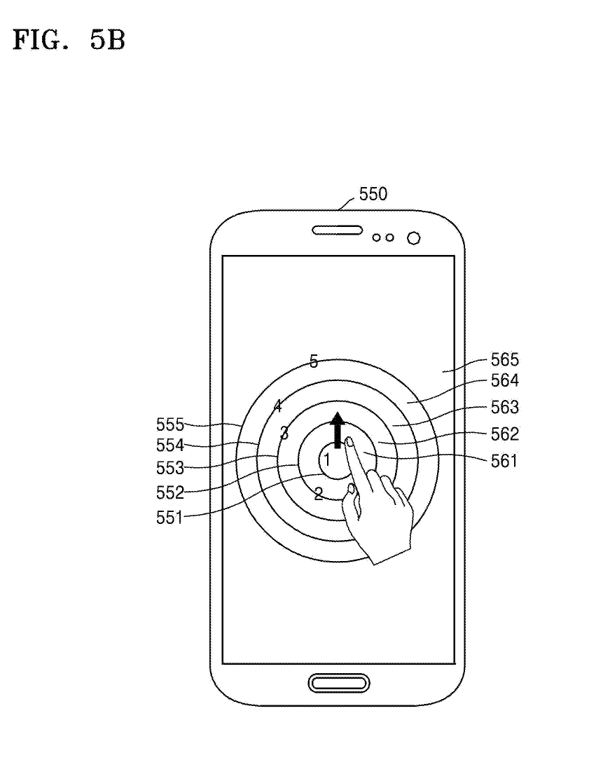

FIGS. 5A and 5B illustrate a method of unlocking a device with an input based on contour lines, according to an exemplary embodiment of the present invention.

In FIG. 5A, the device displays a plurality of contour lines radiating from the reference point. The shape of a contour line in FIG. 5A is rectangular. However, any kind of a polygon or a circle as a contour line can be used based on options provided by the device.

The user may start an unlocking method by touching a central point as a reference point and moving back and forth between the reference point and any of the contour lines 511, 512, 513 and 514. The processor of the device calculates each of the distances between the reference point and the contour lines visited by the user. If the combination of the plurality of inputs in the plurality of directions and the calculated distances is substantially identical to predetermined unlocking data, e.g., a plurality of inputs in a plurality of directions and predetermined distances included in a predetermined unlock pattern, then the device 510 is unlocked from a locked state.

Alternatively, if the processor of the device determines whether a plurality of visits made by the user to a plurality of contour lines 511, 512, 513, and 514 or a plurality of areas 521, 522, 523, and 524 made between the contour lines is identical to a predetermined unlocking data, the device is unlocked from a locked state. For instance, if the predetermined unlocking data comprises visits to the areas of 523, 522 and 524 in sequence from the reference point, the user must visit the areas of 523, 522 and 524 from the reference point in a sequential order to unlock the device.

In the foregoing situation, the direction from the reference point to any of the areas is irrelevant in determining whether the unlocking conditions are satisfied. Similarly, the plurality of visits can be made to any of contour lines 511, 512, 513 and 514 instead of the areas of 521, 522, 523 and 524.

According to an embodiment of the present invention, the device with proximity sensors could be used to detect the movement of user's hands or any other human body part movement. The user can move over the areas without touching the touch sensitive screen of the device by using proximity sensors. The user's movement is taken as the user's input and the sequence detected is compared with the predetermined unlocking data to unlock the device.

A user may use a different kind of contour lines as shown in FIG. 5B. One closed contour line is a circle in accordance with FIG. 5B.

Although FIGS. 5A and 5B are described based on a touch sensitive device, the same unlocking method described in FIGS. 5A and 5B is applicable to the head mounted device 310 and the motion sensitive wearable device such as the smart watch 410.

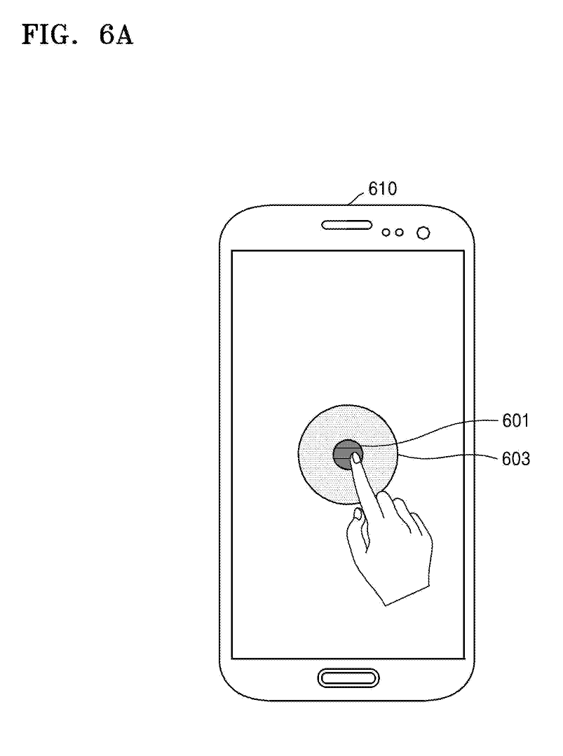

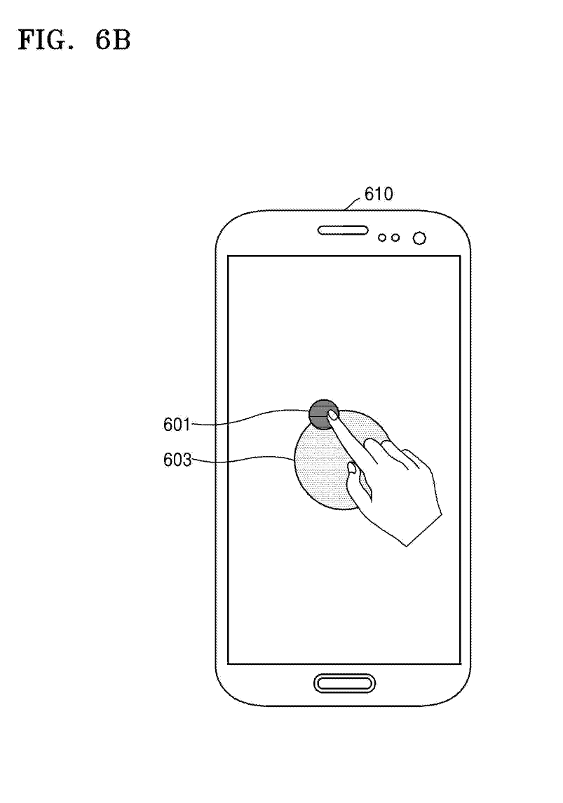

FIGS. 6A and 6B illustrate another method of unlocking a touch sensitive device with a virtual object, according to an exemplary embodiment of the present invention.

Although the method described in reference to FIG. 2 may provide a robust security method by removing patterns from a display of a device, a user with normal eyesight nevertheless may be assisted by pattern guidance to use an unlocking method more conveniently.

In FIG. 6A, if a device is woken-up from a sleep mode, the display of the device displays a circle 603 and a virtual object 601 inside the circle 603. A user may be able to start an unlocking process by touching the virtual object 601 and move the virtual object 601 in predetermined directions to unlock the device. In other words, by allowing the virtual object 601 to move along with in a plurality of directions by a user on the display of the device, the user may unlock the device with increased visual accessibility. To increase the accuracy of the unlocking method, the device recognizes the user's intended direction when the virtual object 601 reaches an edge of the circle 603 as shown in FIG. 6B.

According to another exemplary embodiment of the present invention, when a device is woken-up from a sleep mode, a display of the device does not display the circle 603 and the virtual object 601. Instead, the display displays the circle 603 and/or the virtual object 601 when the user makes the first touch input. Although the first input is a touch input on a touch sensitive device in FIG. 6, it can be different kinds of inputs of different kinds of devices as described referring to FIG. 4 and FIG. 5. For example, if the device is a head-mounted device in FIG. 3A, the first input is an eye movement. Or the first input can be movement of a limb of a user if the device is a motion-sensitive device such as a smart watch of FIG. 4.

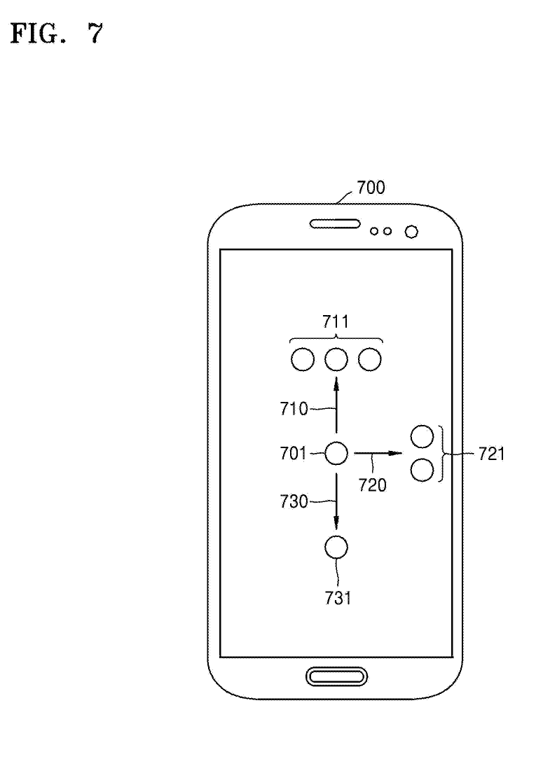

FIG. 7 illustrates another method of unlocking a touch sensitive device with an input based on multiple finger touches, according to an exemplary embodiment of the present invention.

A user may use a combination of multiple finger touches and the direction of touching as an unlocking method. For example, to unlock a device 700, the user may touch a touch sensitive device with three fingers 711 at a reference point 701 and make swipe gestures with his or her three fingers in the up direction 710; touch the touch sensitive device with two fingers 721 at the reference point 701 and make swipe gestures with two fingers in the right direction; and then touch the touch sensitive device with one finger 731 at the reference point and make swipe gestures in the down direction one finger as shown in FIG. 7. The combination of multiple finger touches and the directions can be selected according to user settings for storing predetermined unlocking data.

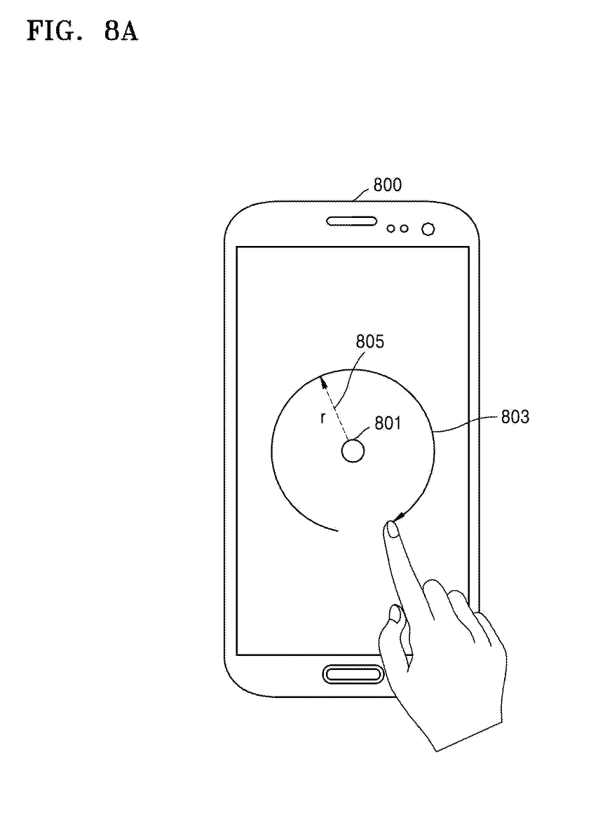

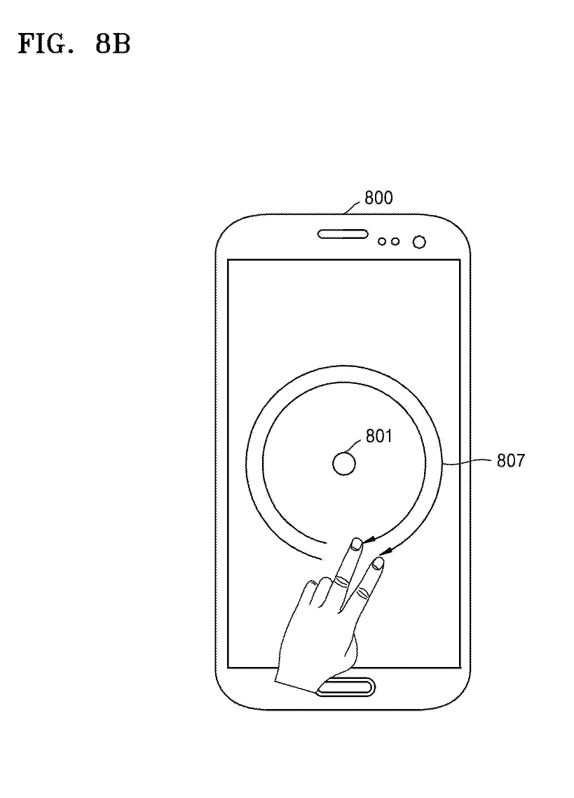

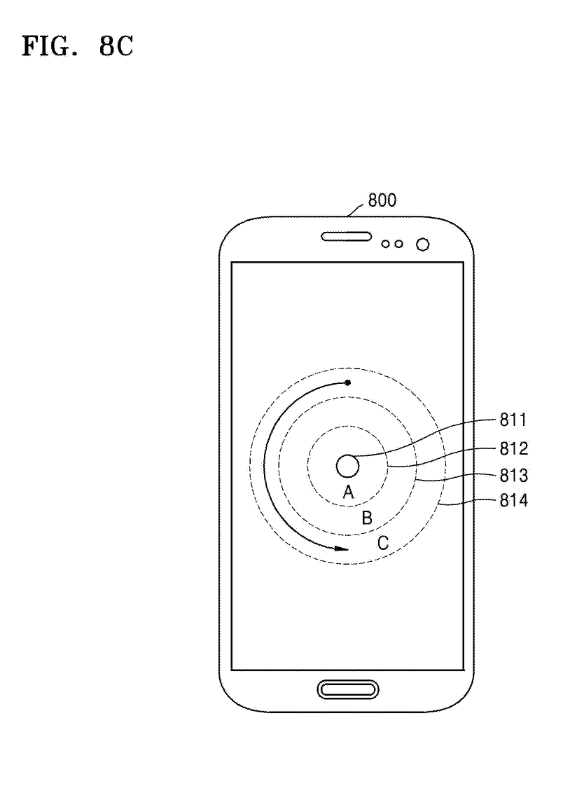

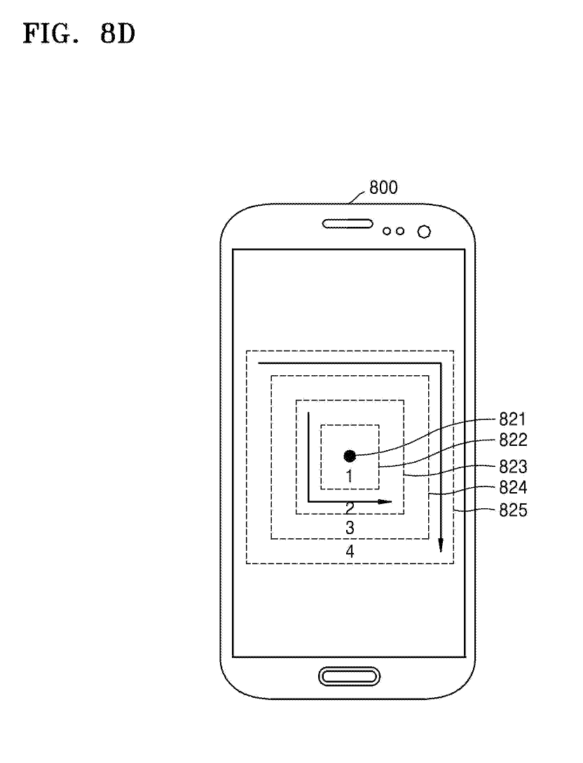

FIGS. 8A through 8D illustrate another method of unlocking a device, according to an exemplary embodiment of the present invention.

Previous embodiments have described continuous touch inputs between a reference point and following-up swipe gestures to accomplish unlocking methods. FIG. 8A illustrates another embodiment of unlocking a device by discontinuous touch inputs between the reference point and swipe gestures.

A user touches the reference point 801 and then within a predetermined time, makes swipe gesture input 803 in a clockwise direction. In this situation, at least one of the swipe gesture input direction and the radius 805 of a circle generated from the swipe gesture input 803 is a critical factor in determining whether to unlock the device. Although FIG. 8A shows one time circular swipe gesture input, continuous circular swipe gestures or alternatively, discontinuous swipe gestures may also contribute to the determination of whether to unlock the device.

FIG. 8B shows another embodiment of unlocking a device by multiple swipe gestures after touching the reference point. Thus, in this situation, the number of fingers touching a display of the device may be a factors contributing to the determination of whether to unlock the device.

In FIG. 8C, a device displays a pattern including a plurality of contour lines. A determination is made whether to unlock the device if a user makes swipe gestures on predetermined areas divided by the contour lines. FIG. 8C shows an example of unlocking the device when swipe gestures are made on an area formed by 813 contour line and 814 contour line. If the user would like to enhance the security level, the user may include a plurality of factors contributing to a method of unlocking the device. Factors are, for instance, a direction of swipe gesture input—clockwise or counter clockwise, user's choice of whether to make a full circle, half circle, or ¼ circle, and user's choice of whether the circle begins from an upper point or a lower point, etc.

For user's convenience, each of areas formed by contour lines from 812 to 814 is identified by letters, numbers, or a combination thereof which are displayed on the device.

FIG. 8D shows another embodiment of unlocking a device by multiple swipe gestures.

The device may be unlocked with a various combinations of touch inputs and swipe gestures.

In FIG. 8D, a combination of the first swipe gesture input from the left top corner to the right bottom corner within an area 2 in a counter clockwise direction and the second swipe gesture input from the left top corner to the right bottom corner within an area 4 in a clockwise direction is compared with a stored predetermined unlocking data, e.g., predetermined swipe gestures, to unlock the device. As understood in reference to FIG. 8D, a user may enhance the security level of the device by combining various touch inputs and swipe gestures for unlocking the device.

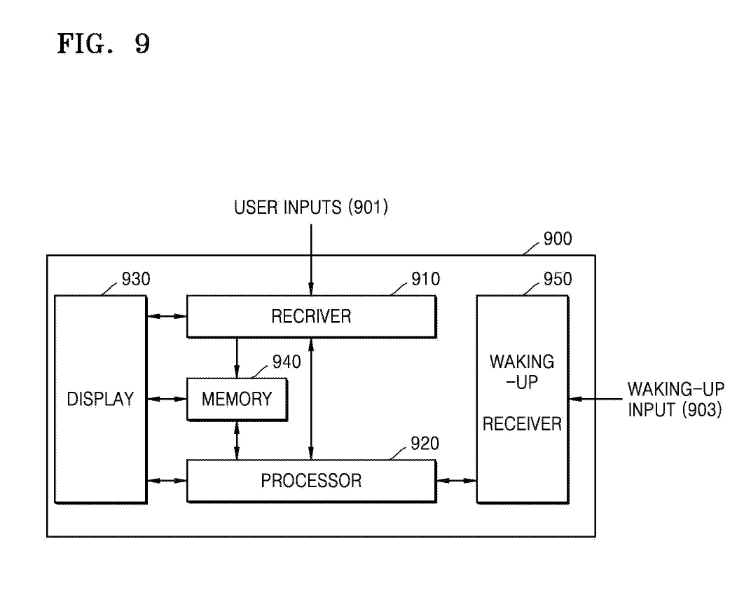

FIG. 9 is a block diagram of an apparatus for unlocking a device, according to an exemplary embodiment of the present invention.

The device 900 can be any of a mobile phone, a head mounted device, a wearable device such as an electronic watch, a vehicle console, a TV, a portable electronic device, and a computing device.

The receiver 910 receives user inputs including a touch input, swipe gestures if the device 900 is a touch sensitive device. User inputs may be eye movements if the device 900 is a head-mounted device. User inputs may be motions of the user if the device 900 is a motion sensitive device.

User inputs are made on a reference point and/or with a plurality of inputs in a plurality of directions on a display 930. For the purpose of unlocking the device, it is preferable to make the first touch input from the reference point so that the device recognizes the start point of an unlocking process.

The processor 920 determines whether the plurality of inputs in the plurality of directions made by the user are substantially identical to a predetermined unlocking path or a predetermined unlocking data stored in a memory 940 of the device.

Of course, the predetermined unlocking path or the predetermined unlocking data is made by a user at a setting mode of the device and is stored in the memory of the device in advance to use unlocking method described herein.

Since the inputs made by a user for unlocking the device might not correspond perfectly to the predetermined unlocking path or data, the inputs may be determined to be acceptable for unlocking the device if the difference between the inputs and the predetermined data falls within a predetermined range. The same principle applies to devices with eye movement inputs or motion inputs.

The waking-up receiver 950 receives a wake-up input from a user. Once the wake-up input is received, the processor may wake up from a sleep mode and/or a power saving mode of the device.

The display 930 displays patterns including at least one of a plurality of contour lines, a closed curve which may be either a circle or a polygon. The display 930 also displays a reference point and/or a virtual object in accordance with the user's choice.

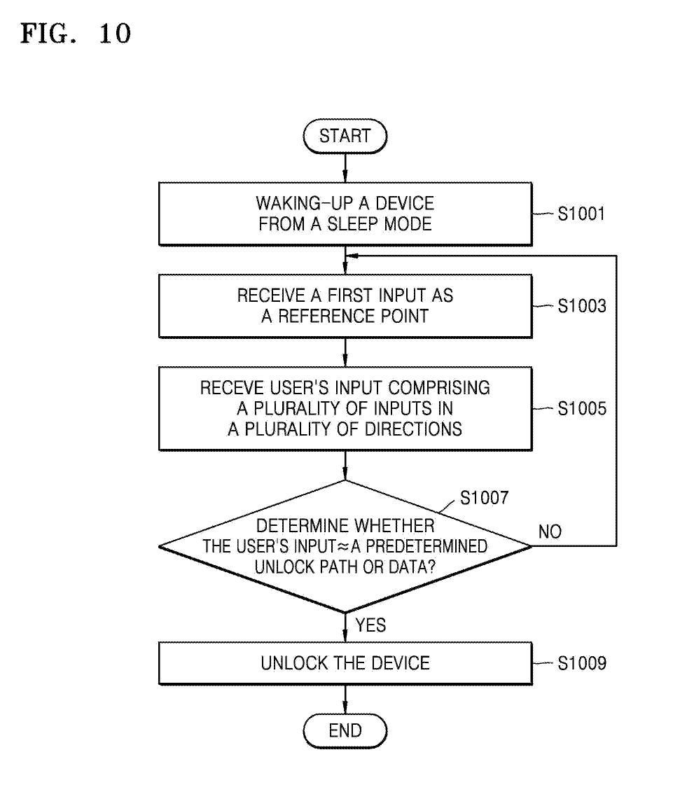

FIG. 10 is a flowchart of a method for unlocking a device, according to an exemplary embodiment of the present invention.

The unlocking process is initiated by waking up a device from a sleep mode or a power-saving mode by a user's wake-up input in operation S1001.

In operation 1003, the device receives a first input indicating a reference point. The reference point can be either a predetermined point or a central point on a display of the device based on the user's predetermined choice. When the device is a touch sensitive device, the device may start an unlocking process only if the predetermined reference point is touched by the user. In another embodiment, the reference point may automatically be set as an arbitrary first touch point of the user and the device may start an unlocking process when the user touches anywhere on the display.

In operation S1005, the device receives user's touch inputs comprising a plurality of touch inputs in a plurality of directions. In fact, the touch inputs in this operation are generally swipe gestures in multiple directions to enhance the security level of the device. The next operation S1007 is to determine whether the foregoing user's touch inputs are substantially identical to a predetermined unlocking path or a predetermined unlocking data. If the determination in S1007 is yes, then the device is unlocked in operation S1009.

In an embodiment of the present invention, unlocking the electronic device comprises analyzing gesture dynamics associated with the plurality of swipe gestures and authenticating the user based on the gesture dynamics for unlocking the electronic device. The gesture dynamics correspond to user input gesture, delay in gesture, finger movement pattern, reach, pressure of the fingers, preferred hand, heat signature and any similar factors.

In an embodiment of the present invention, to authenticate the user, a plurality of biometric sensors are combined to form a combined unlock and authentication mechanism. Here, unlocking the electronic device using the non-visual user interface is performed before waking up the electronic device from an idle mode or after waking the electronic device from the idle mode.

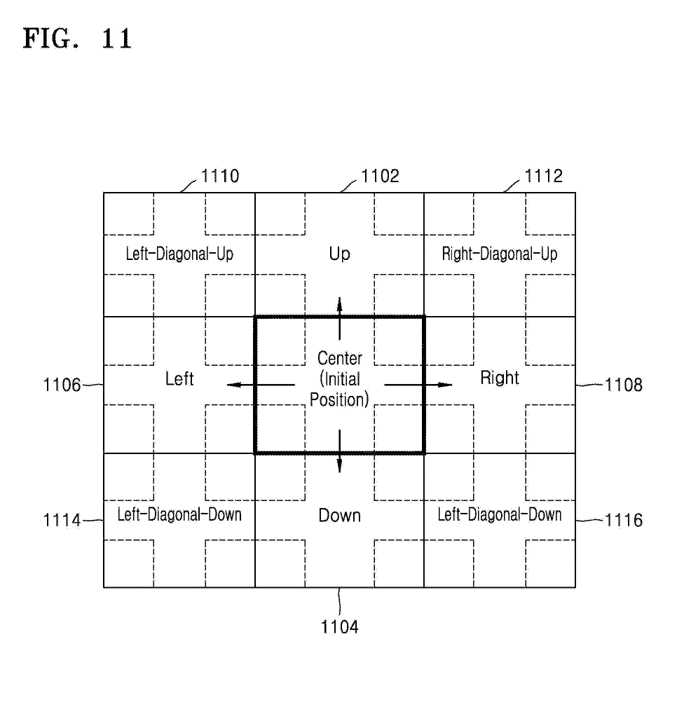

FIG. 11 is a schematic diagram illustrating division of the touch sensitive screen into plurality of sectors with respect to directions from a central point, according to an exemplary embodiment of the present invention. According to the exemplary embodiment of the present invention, a non-visual virtual user interface (UI) divides the touch sensitive screen into at least 2 sectors, depending upon the preference set by the user. The user moves his finger using touch and move interactions from the location which is the first touch interaction after waking up the device. The device gets unlocked if the user visits the sectors continuously or discontinuously in the sequence same as that of predetermined unlocking data. According to an exemplary embodiment, the touch sensitive screen is divided into four sectors such as up, down, left and right directions will allow the user to visit and generate the code sequence to be compared with the predetermined unlocking data. According to another exemplary embodiment, the touch sensitive screen is divided into eight sectors such as directions up 1102, down 1104, left 1106, right 1108, left-diagonal-up 1110, right-diagonal-up 1112, left-diagonal-down 1114, and right-diagonal-down 1116 which will allow the user to visit and generate the code sequence to be compared with the predetermined unlocking data. The whole or part of the touch sensitive screen display could be used to render the present embodiment for unlocking the device.

According to an embodiment of the present invention, there is non-visual or visual virtual UI for the user to provide inputs. Either the non-visual or visual UI could be selected by the user based on the his or her preference, thereby making it easier for both visually impaired and non-visually impaired users.

According to an embodiment of the present invention, the user provides the touch and move interactions by moving his or her finger(s) in the defined sectors to input the sequence. For each move on the touch sensitive screen of a device, there may be an instantaneous feedback from the device to the user and the code corresponding to the sector visited is added to data for unlocking the device. This data for unlocking the device entered by the user is compared with the predetermined unlocking data. The feedback can be in the form of sound, haptic or vibration. The haptic vibration is programmed in such a way that the user is able to identify each sector. This feature is important especially for a visually impaired user, as it helps to identify the position on the touch sensitive screen of the device. If the user loses track of the position while providing the input, the haptic or sound feedback helps the user to resume unlocking process of the device.

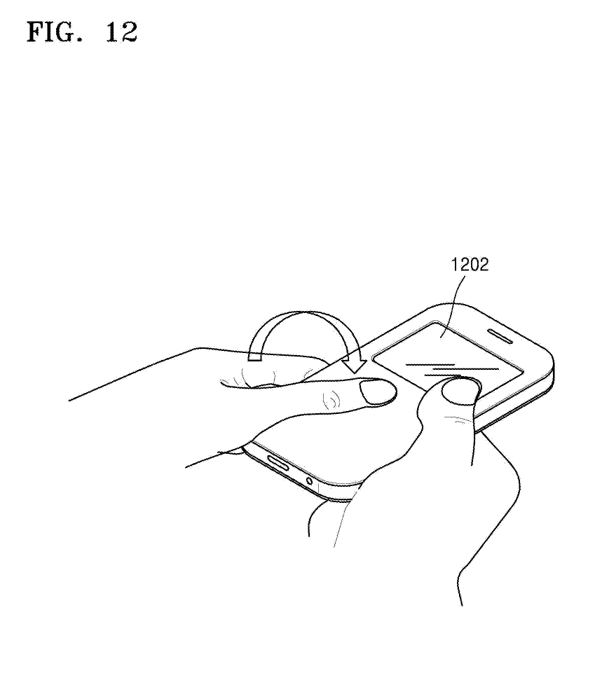

FIG. 12 is a schematic diagram illustrating S cover for unlocking the touch screen, according to another embodiment of the present invention. A user performs the touch interactions in a space on the S cover to unlock the device without opening the S Cover. S cover is an external cover of the device which has a touch surface area 1202 that is available for touch interaction. The user performs the touch interactions on this touch surface area to unlock the device without opening the external cover.

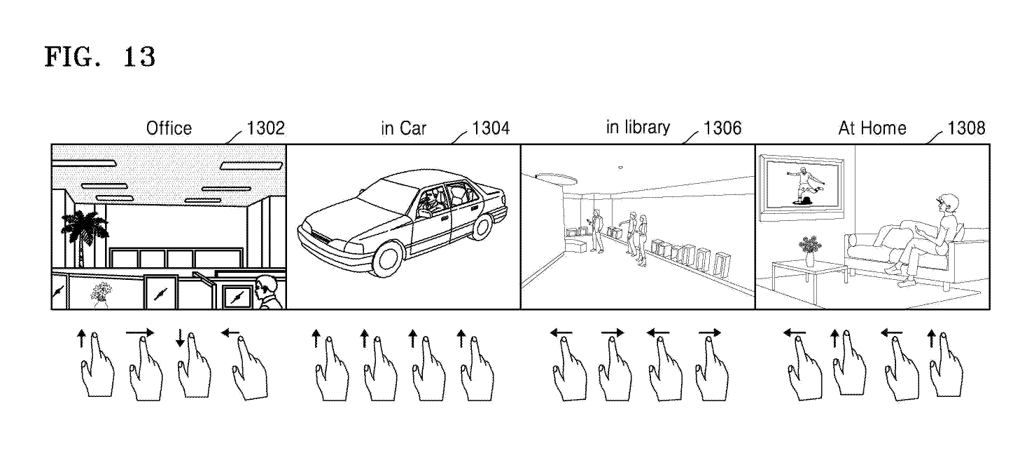

FIG. 13 is a schematic diagram illustrating location based change of unlocking data for unlocking the touch screen, according to an embodiment of the present invention. A user is enabled to set different unlocking data for different locations such as unlocking data at office 1302, unlocking data in car 1304, unlocking data at library 1306 and unlocking data at home 1308. The user needs to input location specific unlocking data for unlocking the device.

The invention can also be embodied as computer-readable codes on a computer readable recording medium. Examples of the computer-readable recording medium include magnetic storage media, optical recording media, and storage media such as carrier waves (e.g., transmission through the Internet). In addition, data formats of messages used in the invention can be recorded on the computer readable recording medium.

While this invention has been shown and described in detail with reference to exemplary embodiments shown in the accompanying drawings thereof, these embodiments are to be regarded as merely exemplary not to limit the invention. Although specific terms are used in the specification, these terms are not used to limit meaning or the scope of the invention disclosed in the claims but used to describe the concept of the invention. Therefore, it will be understood by those of ordinary skill in the art that the invention can be implemented by various modified forms and other equivalent embodiments realizing the principle of the invention through deletion, substitution, or modification in various forms without departing from the essential technical spirit of the invention defined by the appended claims although not clearly described or shown in the specification.

The genuine protection range of the invention should be defined not by the above-described description but by the technical spirit of the appended claims, and it will be analyzed that all structural and functional equivalents within a range equivalent to the genuine protection range of the invention are included in the invention. It will be understood that these equivalents include not only currently publicized equivalents but also equivalents to be developed in the future, i.e., all components invented to perform the same function regardless of their structure.

What is claimed is:

1. A method of unlocking a device, the method comprising:
receiving a first input indicating a reference point;
receiving an input pattern including a plurality of inputs in a plurality of directions, wherein each of the plurality of inputs is initiated from the reference point;
determining whether the plurality of inputs included in the input pattern are identical to a plurality of inputs included in predetermined unlocking data; and
unlocking the device based on the determination.

2. The method of claim 1, further comprising waking up the device from a sleep mode when receiving a wake-up input.

3. The method of claim 1, further comprising:
displaying a plurality of contour lines radiating from the reference point; and
calculating each of a plurality of distances between the reference point and each of the plurality of inputs included in the input pattern,
wherein the determination of whether the plurality of inputs included in the input pattern are identical to the plurality of inputs included in the predetermined unlock pattern comprises:
determining whether a combination of the plurality of inputs included in the input pattern and the plurality of calculated distances are identical to a combination of the plurality of inputs and a plurality of calculated distances included in the predetermined unlock pattern.

4. The method of claim 1, further comprising:
displaying a virtual object on a display of the device based on a determination that the first input is received at a predetermined reference point.

5. The method of claim 1, wherein the reference point is a predetermined point on a display of the device.

6. The method of claim 5, wherein the predetermined point is a central point of the display of the device.

7. The method of claim 1, wherein the reference point is an arbitrary point on a display of the device and the first input is automatically determined to be received at the reference point.

8. The method of claim 1, wherein the plurality of inputs are swipe gestures and the device is a touch sensitive device.

9. The method of claim 8, wherein the receiving of the first input and the receiving of the input pattern are performed discontinuously.

10. The method of claim 1, wherein the plurality of inputs are generated by a plurality of eye movements and the device is a head-mounted device.

11. The method of claim 1, wherein the plurality of inputs are generated by movement of at least one limb of a user and the device is a motion sensitive device.

12. The method of claim 1, wherein the device is one of a mobile phone, a head-mounted device, a electronic watch, a vehicle console, a TV and a computing device.

13. The method of claim 1, further comprising:
displaying a virtual object which is movable on a display of the device; and
moving the virtual object on the display of the device based on the plurality of inputs included in the input pattern.

14. The method of claim 13, wherein the displaying of the virtual object comprises displaying the virtual object at a predetermined location on the display of the device before receiving the first input indicating the reference point.

15. The method of claim 13, wherein the displaying of the virtual object comprises, after receiving the first input indicating the reference point, displaying the virtual object at a location where the first input is received.

16. The method of claim 13, further comprising:
displaying a closed curve on the display of the device,
wherein the moving of the virtual object comprises moving the virtual object based on the plurality of inputs, within the closed curve displayed on the display of the device.

17. The method of claim 16, wherein the closed curve is a circle or a polygon.

18. An apparatus for unlocking a device from a lock state, the apparatus comprising:
a receiver configured to receive a first input indicating a reference point and to receive an input pattern including a plurality of inputs in a plurality of directions, wherein each of the plurality of inputs is initiated from the reference point;
a processor configured to determine whether the plurality of inputs included in the input pattern are identical to a plurality of inputs included in a predetermined unlocking data and to unlock the device from the lock state based on the determination; and
a memory configured to store the predetermined unlocking data.

19. The apparatus of claim 18, further comprising a wake-up receiver configured to receive a wake-up input,
wherein the processor is configured to wake up the device from a sleep mode upon receipt of the wake-up input.

20. The apparatus of claim 18, further comprising:
a display configured to display a virtual object which is movable on the display,
wherein the processor is configured to move the virtual object on the display of the device based on the plurality of inputs included in the input pattern.

21. The apparatus of claim 20, wherein the display is configured to display the virtual object before receipt of the first input indicating the reference input.

22. The apparatus of claim 20, wherein the display is configured to display the virtual object after receipt of the first input indicating the reference input.

23. The apparatus of claim 20, wherein the display is configured to display a closed curve and the processor is configured to move the virtual object based on the plurality of inputs, within the closed curve.

24. The apparatus of claim 23, wherein the closed curve is a circle or a polygon.

25. The apparatus of claim 18, wherein:
the display is configured to display a plurality of contour lines radiating from the reference point, and
the processor is configured to calculate each of a plurality of distances between the reference point and each of the plurality of inputs included in the input pattern and to determine whether a combination of the plurality of inputs included in the input pattern and the plurality of calculated distances are identical to the the plurality of inputs included in predetermined unlocking data.

26. The apparatus of claim 18, wherein the display is configured to display a virtual object based on a determination that the receiver receives the first input at a predetermined reference point.

27. The apparatus of claim 18, wherein the reference point is a predetermined point on a display.

28. The apparatus of claim 18, wherein the reference point is an arbitrary point corresponding to the first input.

29. The apparatus of claim 18, wherein the plurality of inputs are swipe gestures and the apparatus is a touch sensitive device.

30. The apparatus of claim 29, wherein the receiver is further configured to receive the first input and to receive the input pattern discontinuously.

31. The apparatus of claim 18, wherein the plurality of inputs are generated by a plurality of eye movements and the apparatus is a head-mounted device.

32. The apparatus of claim 18, wherein the plurality of inputs are generated by movement of at least one limb of a user.

33. The apparatus of claim 18, wherein the apparatus is one of a mobile phone, a head-mounted device, a electronic watch, a vehicle console, a TV and a computing device.

34. A method of unlocking a device, the method comprising:
receiving a first input indicating a reference point;
receiving an input pattern including a plurality of sequential visits to a plurality of areas on a display of the device;
determining whether the plurality of sequential visits included in the input pattern are identical to a plurality of sequential visits included in a predetermined unlock pattern; and
unlocking the device based on the determination,
wherein the plurality of areas are divided by contour lines radiating from the reference point.

35. The method of claim 34, further comprising displaying numbers or letters on the plurality of areas.

36. The method of claim 34, wherein the plurality of sequential visits are controlled by at least one of touch inputs, eye movements of a user, and movement of at least one limb of the user.
